(19) United States
(12) Patent Application Publication
(10) Pub. No.: US 2007/0204654 A1
(43) Pub. Date: Sep. 6, 2007

(54) Method and apparatus for manufacturing optical element

(75) Inventors: Naoyuki Fukumoto, Amagasaki-shi (JP); Toshiharu Mori, Osaka (JP); Shuji Ikenaga, Kashiba-shi (JP)

Correspondence Address: BRINKS HOFER GILSON & LIONE, P.O. BOX 10395, CHICAGO, IL, 60610, US

(73) Assignee: Konica Minolta Opto, Inc., Tokyo (JP)

(21) Appl. No.: 11/651,791

(22) Filed: Jan. 10, 2007

(30) Foreign Application Priority Data
Jan. 11, 2006 (JP) JP 2006-003613

(51) Int. Cl. C03B 18/18; C03B 11/00; C03B 5/24; G02B 3/00

(52) U.S. Cl. 65/29.19; 65/66; 65/162; 65/305; 359/642

(57) ABSTRACT

A glass material is press-molded by an upper die and a lower die in a closed space, so that an optical element is manufactured. A temperature variation of an atmosphere in the closed space is controlled within ±0.5° C. The glass material is dropped from a nozzle of a fusion furnace onto the lower die. A dropping space between the nozzle and the lower die which receives molten glass droplets is surrounded by an enclosure. Further, a die moving space in which the lower die moves from the dropping position where the molten glass is dropped to a molding position where the upper die stands by is enclosed by another enclosure. The molten glass dropped from the nozzle of the fusion furnace is press-molded in an atmosphere of stable temperature, so that optical glass elements with less variation can be manufactured.

The present application claims priority to Japanese Patent Application No. 2006-3613 filed Jan. 11, 2006, the entire content of which is hereby incorporated by reference.

### BACKGROUND OF THE INVENTION

1. Field of the Invention

The present invention relates to a method and an apparatus for manufacturing optical element in which molten glass droplets flown from a nozzle is press-molded in a pair of dies.

2. Description of the Related Art

When glass products such as optical glass elements including lenses and prisms are molded with high precision, it is examined that molten glass which is naturally dropped in a droplet shape from a nozzle of a fusion furnace by gravitational force is used.

In general, the molten glass is dropped onto a lower die, the lower die on which a molten glass droplet is placed is moved to an upper die, so that the glass droplet is press-molded in a pair of upper and lower dies (for example, see Japanese Patent Application Laid-Open No. 2002-234740).

When the molten glass is dropped as a molten glass droplet from the nozzle, the temperature and the shape of the molten glass droplets delicately vary according to atmospheres. That is to say, the shape and the dropping position of the molten glass droplets vary due to unstable atmosphere. When a molten glass droplet is press-molded in the paired dies in such a state, a center thickness and yield of molded optical glass elements are not good.

### SUMMARY OF THE INVENTION

A main object of the present invention is to provide a method and an apparatus for manufacturing optical elements with less variation in such a manner that glass materials are supplied stably to a predetermined position without being influenced by an atmosphere.

In order to attain this object and the other objects, from a certain aspect of the present invention, a method of manufacturing an optical element includes the steps of:

controlling a temperature variation of an atmosphere in a closed space within a predetermined range; and

press-molding a glass material in dies so as to manufacture the optical element in the closed space.

When the entire molding atmosphere is made to be the closed space and the temperature variation of the molding atmosphere is controlled within the predetermined range, the entire molding atmosphere is hardly influenced by the temperature variation due to a change in air current. As a result, satisfactory optical glass elements can be manufactured with good reproducibility.

The invention itself, together with further objects and attendant advantages, will best be understood by reference to the following detailed description taken in conjunction with the accompanying drawings.

### BRIEF DESCRIPTION OF THE DRAWINGS

FIG. 1 is a diagram schematically explaining a main section of an optical element manufacturing apparatus according to the present invention;

FIG. 2 is a diagram explaining an entire constitution of the optical element manufacturing apparatus according to the present invention;

FIG. 3 is a diagram illustrating a state that molten glass is dropped from a nozzle of the optical element manufacturing apparatus;

FIG. 4 is a diagram illustrating a dropping position where the molten glass is dropped from the nozzle: x shows the case where the molten glass is dropped by a method of the present invention, and ∘ shows the case where the molten glass is dropped by a conventional method; and

FIG. 5 is a diagram illustrating shape accuracy of an optical element at the time of press-molding a molten glass droplet: x shows the case where the molten glass is dropped by the method of the present invention, and o shows the case where the molten glass is dropped by the conventional method.

In the following description, like parts are designated by like reference numbers throughout the several drawing.

### DETAILED DESCRIPTION OF THE PREFERRED EMBODIMENTS

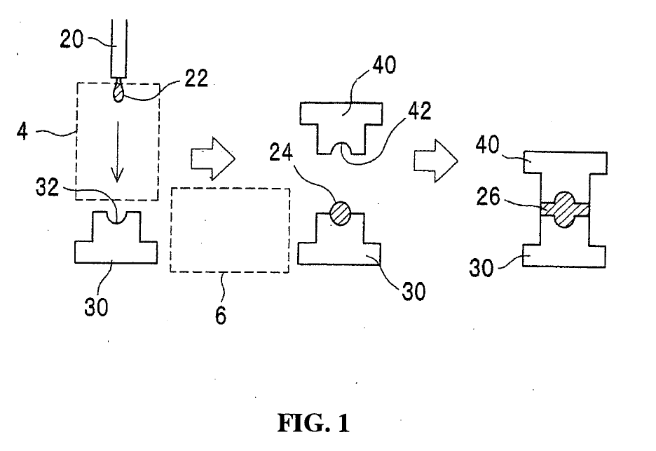

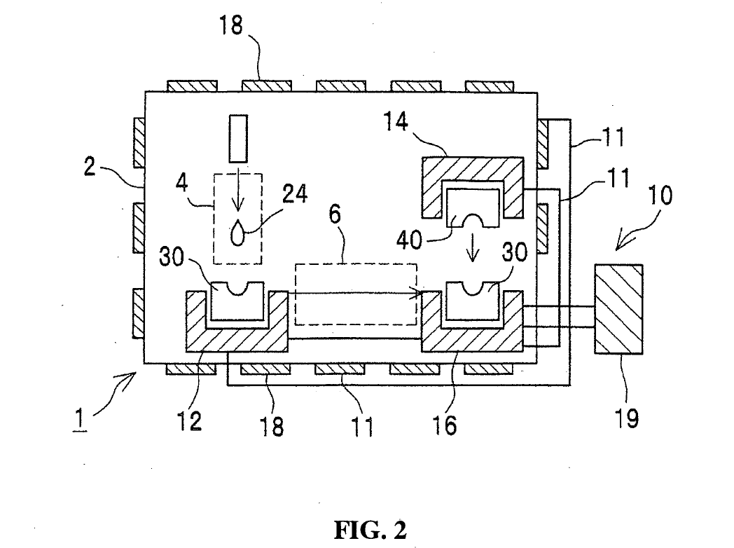

A method and an apparatus for manufacturing optical elements according to one embodiment of the present invention are explained in detail below with reference to FIGS. 1 and 2.

FIG. 1 is a diagram schematically explaining a main section of an optical element manufacturing apparatus 1 according to the present invention, and FIG. 2 is a diagram explaining an entire constitution of the optical element manufacturing apparatus 1 according to the present invention.

As shown in FIG. 2, the optical element manufacturing apparatus 1 according to the present invention includes a molten glass feed unit that feeds a molten glass droplet 24 to a lower die 30, and a press-molding unit that press-molding the molten glass droplet 24 using a pair of upper and lower dies 30 and 40. The molten glass feeding unit and the press-molding unit are provided into an air-tight entire enclosure 2.

Respective wall surfaces of the entire enclosure 2 are provided with a plurality of cooling units 18. The cooling units 18 are maintained at a predetermined constant temperature by a temperature adjuster 19 of a cooling device 10 via cooling water flowing through a cooling pipe 11. Similarly, lower die cooling units 12 and 16 and an upper die cooling unit 14 also are maintained at a predetermined constant temperature by the temperature adjuster 19 of the cooling device 10 via the cooling water flowing through the cooling pipe 11.

The molten glass feed unit is basically composed of a fusion furnace that fuses glass, a nozzle 20 that is provided on a bottom portion of the fusion furnace and leads the molten glass 22 to the outside, the lower die 30 that is in a dropping position where the molten glass droplet 24 naturally dropped from a front edge of the nozzle 20 is received, and a droplet space enclosure 4 that encloses a droplet space between the nozzle 20 and the lower die 30 in the dropping position.

The temperatures of the fusion furnace and the nozzle 20 are maintained at a predetermined temperature by a heater. The dropping interval of the molten glass droplets 24 is basically constant. A droplet detecting sensor, which is composed of a pair of light emitter and a light receiver provided in the mid portion of a dropping path of the molten glass droplets 24, detects the passing of the molten glass droplets 24. A detected signal is sent to a controller, and is fed back to the heater, so that the dropping interval can be controlled more accurately. The dropping interval can be arbitrarily set by a balance of the heater. In order to provide stable dropping, the interval is about 1 to 20 seconds preferably.

In order to heat the fusion furnace and the nozzle 20, a heater, a high-frequency coil, an infrared lamp or the like can be used. Particularly when they are heated to a high temperature of 1000° C. or more, the high-frequency heating is effective.

A portion between the portion just below the front edge of the nozzle 20 and the portion just above the lower die 30 in the dropping position is enclosed by the dropping space enclosure 4 having heat resistance made of stainless or the like, so that the dropping space is formed. The dropping space is, therefore, hardly influenced by a change in an air current and a temperature change due to the change in the air current.

When the molten glass 22 is flown out from the nozzle front edge and the front edge of the flown-out molten glass 22 grows to the molten glass droplet 24 having predetermined weight, the molten glass droplet 24 is naturally dropped by its own weight. The naturally dropped molten glass droplet 24 is received as glass gob on a lower die molting surface 32 having a concave surface of the lower die 30 in the dropping position. The lower die 30 is preferably arranged 10 to 50 cm below the front edge of the nozzle 20.

The temperature of the lower die 30 may be a room temperature, and the temperature control is not particularly necessary. When the temperature of the lower die 30 is too low, however, crease easily occurs on the glass gob, and thus the temperature control by means of the heating unit and the lower die cooling unit 12 is effective. The upper die 40 does not particularly require the temperature control, but the temperature control by means of the heating unit and the upper die cooling unit 14 is effective.

As the lower die 30 and the upper die 40, heat-resistant materials such as ceramic, sintered hard alloy, carbon and metal can be used, but from the viewpoint of good thermal conductivity and low reactivity with respect to glass, carbon and ceramic are preferable.

The lower die 30 which receives the molten glass droplet 24 in the dropping position slides to move in a horizontal direction to a molding position where the upper die 40 stands by. The space where the lower die 30 moves horizontally between the dropping position and the molding position is enclosed by a die moving space enclosure 6 having heat resistance made of stainless or the like, so that the die moving space is formed. The die moving space is, therefore, hardly influenced by a change in air current and a temperature variation due to the change in air current.

In the molding position, the upper die 40 is arranged above the upper die in an opposed manner. The upper die 40 is driven to an up-down direction by a press-molding unit. The molten glass droplet 24 placed on the lower die molding surface 32 of the lower die 30 is pressure-molded between the lower die molding surface 32 of the lower die 30 and an upper die molding surface 42 of the upper die 40.

In the manufacturing apparatus 1 having the above constitution, the temperatures of the cooling units 12, 14, 16 and 18 are maintained within ±2° C., and the ambient temperature in the manufacturing apparatus 1 falls within ±5° C. of a predetermined temperature. It is preferable that the temperatures of the cooling unit 12, 14, 16 and 18 are controlled within ±0.5° C., and as a result, the ambient temperature in the manufacturing apparatus 1 can be controlled within ±0.5° C. of the predetermined temperature.

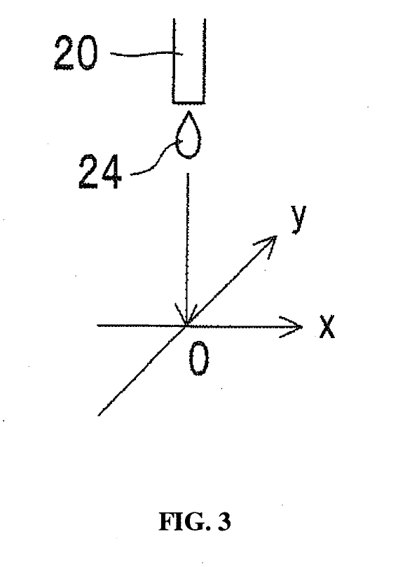

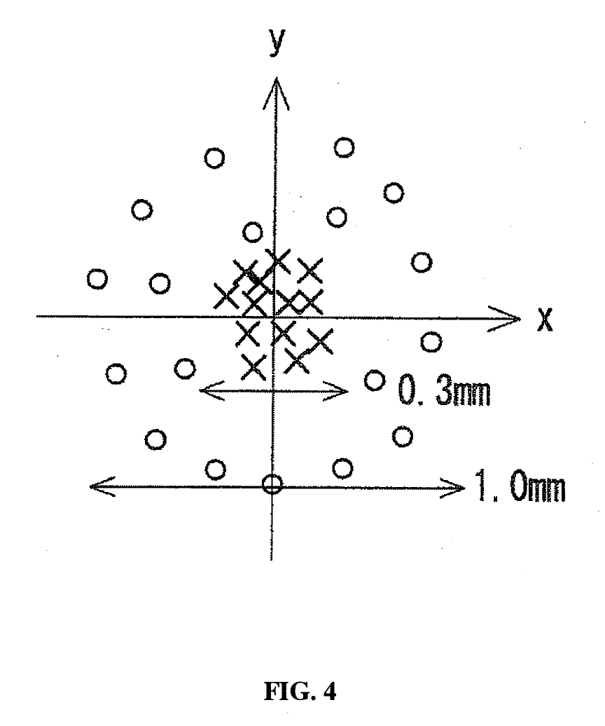

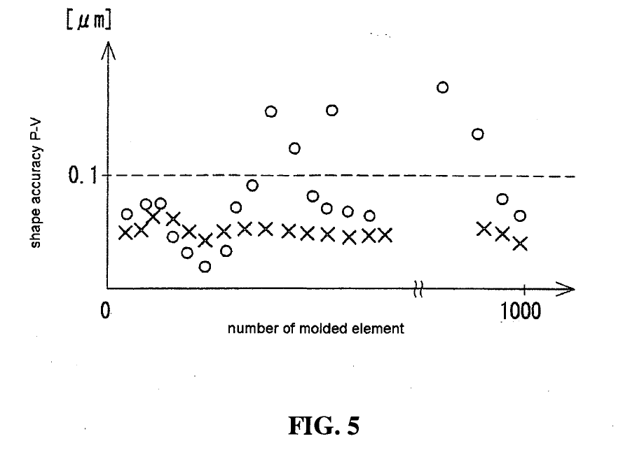

A measured result of the effect of repressing a temperature variation of the molding atmosphere is explained below with reference to FIGS. 3 to 5. In FIGS. 4 and 5, x relates to the present invention where a closed space whose temperature is controlled by the enclosures 2, 4 and 6 (the ambient temperature is controlled within ±0.5° C.) is formed, and ∘ relates to a comparative example in an opened environment.

### EXAMPLE

An optical element (center thickness: 2.5 mm) was manufactured by using the upper die 40 and the lower die 30 whose upper die molding surface 42 and lower die molding surface 32 has a concave shape in the apparatus 1 shown in FIGS. 1 and 2. Molten glass 22 (SF57 glass) was heated to 1000° C. by a platinum crucible, and a molten glass droplet 24 with weight of 3.5 g was dropped from the nozzle 20 onto the lower die 30. The nozzle 20 was separated from the lower die 30 by a distance of about 30 cm, and the molten glass 22 was dropped continuously with interval of about 3 seconds.

At this time, a variation in the dropping positions of the molten glass droplets 24 was examined. In the manufacturing apparatus 1, the temperatures of the cooling units 12, 14, 16 and 18 were controlled within ±0.5° C. of a room temperature, and as a result, the ambient temperature in the manufacturing apparatus 1 could be controlled within ±0.5° C. of the room temperature.

As is clear from FIG. 4, in the present invention where the closed space whose temperature was controlled by the enclosure was formed, the dropping position of the molten glass droplets 24 fell within 0.3 mm, and thus the variation in the dropping position of the molten glass droplets 24 was small. Also the variation in the center thickness of the molten glass droplets 24 was small. On the contrary, in the case of the comparative example in the opened environment, the molten glass droplets 24 were dropped with variation of about 1.0 mm. Also the variation in the center thickness of the molten glass droplets 24 was large.

The molten glass droplets 24 dropped onto the lower die 30 were press-molded sequentially and repeatedly by the upper die 40 and the lower die 30 1000 times. The shape accuracy of the optical elements obtained by the press molding was measured. As a result, as is clear from FIG. 5, in the present invention where the closed space whose temperature was controlled by the enclosure was formed, the shape accuracy of the optical elements fell within 0.1 μm, and thus a variation in the shape accuracy of the optical elements was small. On the contrary, in the case of the comparative example in the opened environment, the shape accuracy of the optical elements included ones which exceed 0.1 μm, namely, have accidental shape error. At a series of the molding steps, the temperature of the lower die 30 was controlled to 450° C., and the temperature of the upper die 40 was controlled to 420° C.

The present invention, therefore, provides the method and the apparatus for stably providing glass materials to a predetermined position without being influenced by atmospheres so as to manufacture optical elements with less variation.

The optical elements obtained by the press molding of the present invention may be final products or may be preform which is remolded to obtain final products.

The final products which are preferably obtained by the press molding according to the present invention are comparatively small optical elements such as photographing lenses for portable devices such as mobile phones, and optical elements for pick-up of recording media such as DVD. Since particularly pick-up lenses for next-generation DVDs such as Blue Ray Disc and HD-DVD require high precision, they are effectively manufactured by the present invention.

Although the present invention has been fully described by way of examples with reference to the accompanying drawings, it is to be noted that various changes and modifications will be apparent to those skilled in the art. Therefore, unless such changes and modification depart from the scope of the present invention, they should be constructed as being included therein.

What is claimed is:

1. A method of manufacturing an optical element, comprising the steps of:
controlling a temperature of an atmosphere in a closed space within a predetermined range; and
press-molding a glass material in dies so as to manufacture the optical element in the closed space.

2. A-manufacturing method according to claim 1, wherein a variation of the temperature in the closed space is controlled within ±5° C.

3. A manufacturing method according to claim 1, wherein an entire enclosure which encloses the entire of a molding atmosphere is cooled by a cooling medium.

4. A manufacturing method according to claim 3, wherein the variation of the temperature of the cooling medium is controlled within ±2° C.

5. A manufacturing method according to claim 1, wherein the glass material is a molten glass droplet which is naturally dropped.

6. A manufacturing method according to claim 5, wherein a droplet space where the molten glass drops to a lower die is enclosed by the droplet space enclosure.

7. A manufacturing method according to claim 1, wherein the space where the lower die moves between the dropping position where the molten glass drops and the molding position where an upper die stands by is enclosed by a die moving space enclosure.

8. An optical element manufactured by a method comprising the steps of:
controlling a temperature of an atmosphere in a closed space within a predetermined range; and
press-molding a glass material in dies so as to manufacture the optical element in the closed space.

9. An optical element according to claim 8, wherein the optical element is an element for pick-up of recording medium.

10. A manufacturing apparatus which manufactures an optical element, said apparatus comprising:
dies for which press-molds a glass material;
an entire enclosure which encloses the entire of the manufacturing apparatus; and
a controller which controls the temperature of an atmosphere in a closed space within a predetermined range.

11. A manufacturing apparatus according to claim 10, wherein said controller controls a variation of the temperature in the closed space within ±5° C.

12. A manufacturing apparatus according to claim 10, further comprising a cooling device which cools said entire enclosure by a cooling medium.

13. A manufacturing apparatus according to claim 12, wherein said controller controls the temperature of the cooling medium within ±2° C. of a predetermined temperature.

14. A manufacturing apparatus according to claim 10, wherein the glass material is a molten glass droplet which is naturally dropped from a nozzle of a fusion furnace.

15. A manufacturing apparatus according to claim 14, further comprising a droplet space enclosure which encloses a droplet space between the nozzle and the lower die receiving the molten glass droplet.

16. A manufacturing apparatus according to claim 14, further comprising a die moving space enclosure which encloses the space where the lower die moves between the dropping position where the molten glass drops and the molding position where an upper die stands by.
